(19) United States
(12) Patent Application Publication
(10) Pub. No.: US 2026/0259147 A1
(43) Pub. Date: Sep. 3, 2026

(54) System and Method for Automated or Semi-Automated Inspection of Electronic Assemblies

(71) Applicant: Vitrox Technologies SDN. BHD, BANDAR CASSIA (MY)

(72) Inventors: Zhao Hong LIM, SUNGAI JAWI (MY); Yeong Khang NG, BUTTERWORTH (MY); Adrian Kheng Hoeng THONG, PERAI (MY); Xiao LOH, GEORGETOWN (MY); Hwei Li LOW, ULU KINTA (MY); Nicholas Yang Eow Yong OW, PULAU PINANG (MY); Nigel Jian Hsee LEE, AYER ITAM (MY); Lay Yan TAN, BUTTERWORTH (MY)

(21) Appl. No.: 19/552,884

(22) Filed: Feb. 27, 2026

(30) Foreign Application Priority Data
Feb. 28, 2025 (MY) PI2025001409

(51) Int. Cl. G01N 21/88; G01N 21/93

(52) U.S. Cl. CPC G01N 21/8803; G01N 21/8851; G01N 21/93; G01N 2021/8854; G01N 2021/8883; G01N 2021/8887

(57) ABSTRACT

A system for automated or semi-automated inspection of electronic assemblies includes at least one image capturing component for capturing images of electronic components of an electronic assembly under inspection, a database for storing one or more inspection recipes and the images, and one or more processors operating a plurality of modules that include any one, or a combination of, at least one inspection recipe validation module, and at least one inspection recipe optimization module. The inspection recipes are each executed by at least one processor for inspection of at least one electronic assembly based on the images. The inspection recipe validation module is configured to validate the inspection recipes. The inspection recipe optimization module is configured to optimize the inspection recipes based on the images, associated inspection results of the images, associated inspection verification categories of the images, or a combination thereof. A corresponding method is further described.

### CROSS-REFERENCE TO RELATED APPLICATIONS

This application claims priority to, and the benefit of, Malaysian Patent Application No. PI2025001409, filed Feb. 28, 2025, the contents of which are incorporated by reference herein in their entirety.

### TECHNICAL FIELD

The invention relates to the field of electronics. More specifically, a system and method for automated or semi-automated inspection of electronic assemblies for accurate identification of their defects.

### BACKGROUND

Typically, failures within electronic assemblies arise from defects in their electronic components. Examples of such defects may include wrong orientation of electronic components, usage of wrong electronic components as substitute components, etc. To detect such defects, the usage of computer vision for performing inspection of electronic assemblies using an inspection recipe is conventionally used. Furthermore, the advent of machine learning has further enabled automated assistance in this process.

There are a few disclosed technologies over the prior art relating to systems and methods for inspecting electronic assemblies. Among them include WO2021232149A1, which discloses a system and a method for vision inspection of electronics that involve the generation and optimization of one or more defect classification models. Another disclosed technology is WO2007035834A2, which discloses a kind of method and system for creating a recipe for a defect review process for a specimen. After the identity of the specimen is determined and the inspection results have been identified, a stored recipe may be searched from its database for the defect review process, with one or more identifiers from the inspection results. However, it is noted that the aforementioned prior arts fail to provide means to optimize an inspection recipe for it to be less susceptible to providing erroneous inspection results such as false calls and escapes. Accordingly, a system and method for inspecting electronic assemblies that is capable of overcoming this susceptibility is much desired.

### BRIEF SUMMARY

The main objective of the present invention is to provide a system and method for automated or semi-automated inspection of electronic assemblies that validates and optimizes inspection recipes based on inspected electronic assemblies for the inspection recipe to achieve a more accurate performance over time.

The present invention intends to provide a system for automated or semi-automated inspection of electronic assemblies, comprising at least one image capturing component for capturing images of one or more electronic components of at least one electronic assembly under inspection, at least one database for storing one or more inspection recipes and the images, and one or more processors operating a plurality of modules that include any one or a combination of at least one inspection recipe validation module, and at least one inspection recipe optimization module. The inspection recipes are each executed by at least one processor for inspection of at least one electronic assembly based on the images, the inspection recipe validation module is configured to validate the inspection recipes, and the inspection recipe optimization module is configured to optimize the inspection recipes based on the images, associated inspection results of the images, associated inspection verification categories of the images, or a combination thereof.

Preferably, the inspection recipe validation module is further configured to validate at least one inspection recipe based on any one or both the images from the database and images that are artificially generated by the inspection recipe validation module based on the images from the database, for validated inspection recipes to be stored in the database. Preferably as well, the inspection recipe optimization module is further configured to optimize one inspection recipe that was executed for inspection of one corresponding type of electronic assembly, in which the inspection recipe is fine-tuned to determine specific electronic component-related defects on the electronic assembly.

Preferably, the inspection recipe validation module is further configured to receive at least one inspection recipe that was optimized by the inspection recipe optimization module for its validation.

Preferably, the inspection recipes each comprise an inspection region determination component, which is configured to determine at least one inspection region within the images, upon execution of the inspection recipe, an inspection area determination component, which is configured to determine at least one area of interest within the determined inspection regions, upon execution of the inspection recipe, and a defect classification determination component, which is configured to determine at least one defect from the determined area of interest, upon execution of the inspection recipe.

Preferably, the modules further include any one or a combination of an inspection recipe generation module, which is configured to generate the one or more inspection recipes, an inspection recipe execution module, which is configured to manage execution of at least one inspection recipe for inspecting the electronic assembly based on the images to produce the associated inspection results, and an inspection result verification module, which configured to produce the associated inspection verification categories based on any one or both the images of the electronic assembly under inspection and the associated inspection results.

The present invention further intends to provide a method for automated or semi-automated inspection of electronic assemblies, comprising the steps of storing one or more inspection recipes in at least one database, capturing images of one or more electronic components of at least one electronic assembly under inspection, by at least one image capturing component, storing the images in at least one database, and operating a plurality of modules, by one or more processors, in which the modules include any one or a combination of at least one inspection recipe validation module, and at least one inspection recipe optimization module. The inspection recipes are each executed by at least one processor for inspection of at least one electronic assembly based on the images, the inspection recipe validation module is configured to validate the inspection recipes, and the inspection recipe optimization module is configured to optimize the inspection recipes based on the images, associated inspection results of the images, associated inspection verification categories of the images, or a combination thereof.

Preferably, the method further comprises the step of validating at least one inspection recipe based on any one or both the images from the database and images that are artificially generated based on the images from the database, by the inspection recipe validation module.

Preferably, the method further comprises the step of optimizing at least one inspection recipe that was executed for inspection of one corresponding type of electronic assembly for fine-tuning the inspection recipe for it to determine specific electronic component-related defects on the corresponding type of electronic assembly, by the inspection recipe optimization module.

Preferably, the method further comprises the step of receiving at least one inspection recipe that was optimized by the inspection recipe optimization module, by the inspection recipe validation module, for its validation.

One skilled in the art will readily appreciate that the invention is well adapted to carry out the objects and obtain the ends and advantages mentioned, as well as those inherent therein. The embodiments described herein are not intended as limitations on the scope of the invention.

### BRIEF DESCRIPTION OF THE DRAWINGS

To facilitate an understanding of the invention, there are illustrated in the accompanying drawings the preferred embodiments from an inspection of which when considered in connection with the following description, the invention, its construction and operation and many of its advantages would be readily understood and appreciated.

FIG. 1 is an example block diagram illustrating a representation of the system of the present invention for inspecting electronic assemblies according to a first example embodiment.

FIG. 2 is an example block diagram illustrating a representation of the system of the present invention for inspecting electronic assemblies according to a second example embodiment.

FIG. 3 is an example block diagram illustrating a representation of an inspection recipe creation unit within the system of the present invention.

FIG. 4 is an example block diagram illustrating a representation of an inspection recipe validation unit within the system of the present invention.

FIG. 5 is an example block diagram illustrating a representation of a database within the system of the present invention.

FIG. 6 is an example block diagram illustrating a representation of an inspection unit within the system of the present invention.

FIG. 7 is an example block diagram illustrating a representation of an inspection result verification unit within the system of the present invention.

FIG. 8 is an example block diagram illustrating a representation of an inspection result optimization unit within the system of the present invention.

FIG. 9 is a flowchart that illustratively describes an example method of the present invention for inspecting electronic assemblies.

FIG. 10 is a continuation of the flowchart of FIG. 9.

### DETAILED DESCRIPTION

The present invention relates to a system and method for automated or semi-automated inspection of electronic assemblies. The invention may also be presented in a number of different embodiments with common elements.

According to the concept of the invention, there is included one or a combination of computing units that may be generally configured to [i] validate of at least one inspection recipe, [ii] capture one or more images of electronic components of an electronic assembly being an object under inspection, [iii] identify one or more defects present within the electronic components of the electronic assembly based on the captured images through execution of an inspection recipe that may have been validated to obtain one or more inspection results, [iv] verify the inspection results by associating each of them to a relevant inspection verification category, and [v] optimize the aforementioned inspection recipe based on the inspection results and their associated inspection verification category.

In particular, any one or a combination of the aforementioned computing units may utilize artificial intelligence, i.e. machine learning models, to enable automation of their processes with or without supervision from a user. It is to be noted that the machine learning models may be trained or pre-trained, or in more advance implementations, are capable of performing semi-supervised learning or self-supervised learning.

From hereon, it is to be noted that the term “electronic assembly” broadly refers to an electronic device assembled with one or more electronic components. An electronic assembly, may be, by way of example, a printed circuit board with electronic components that are based on surface-mount technology and/or through-hole technology, or the like. In particular, one type of electronic assembly may differ from another type of electronic assembly by having a different layout of electronic components.

From hereon, it is to be noted that the term “inspection recipe” refers to one or more sets of instructions that may be computer-readable and executable by a processor to perform computations for any one of the computing units to [i] perform inspection upon images of objects, and [ii] determine defects on the objects to provide inspection results. In the context of machine learning, the inspection recipe may further include machine learning parameters, which may be, by way of example, weights and biases for one or more machine learning models.

In the context of the present invention, the sets of instructions of the inspection recipe may relate to one or more components, wherein the components of the inspection recipe each have one or more parameters, algorithms, or a combination thereof, which define a function of the inspection recipe. In particular, one inspection recipe may comprise at least one inspection region determination component, at least one inspection area determination component, and at least one defect classification component.

In the context of the present invention, the inspection recipe may be configured to be involved in checking for defects of electronic components on an electronic assembly based on any one or both optical character recognition (OCR) and optical character verification (OCV). In particular, the inspection recipe may further enable handling of defects and/or further perform detection of defects. The defects may further include or cover, but shall not be limited to, any one or a combination of poor setup of the electronic component on the electronic assembly, poor print mark quality of the electronic component, swapped electronic components on the electronic assembly, wrongly placed electronic components on the electronic assembly, missing electronic components on the electronic assembly, electronic components on the electronic assembly that have wrong polarities, missing solder on the electronic components on the electronic assembly, or the like.

From hereon, it is to be noted that the term “machine learning” is used broadly to substantially cover any computerized learning means that uses collected data from the environment to infer one or more patterns therein. This term may also substantially cover computerized learning means that include, but shall not be limited to deep learning, logic analysis, statistical analysis, or the like.

From hereon, it is to be noted that the term “processor” refers to a component or device that performs the scheduling and the execution of software instructions or computer logic instructions based on an application software to operate one or more modules. It may be a conventional processor, an application-specific integrated circuit (ASIC), a field-programmable gate array (FPGA), a processor specializing in graphics processing and/or mathematical calculations, or a combination thereof.

The invention will now be described in greater detail, by way of example, with reference to the drawings.

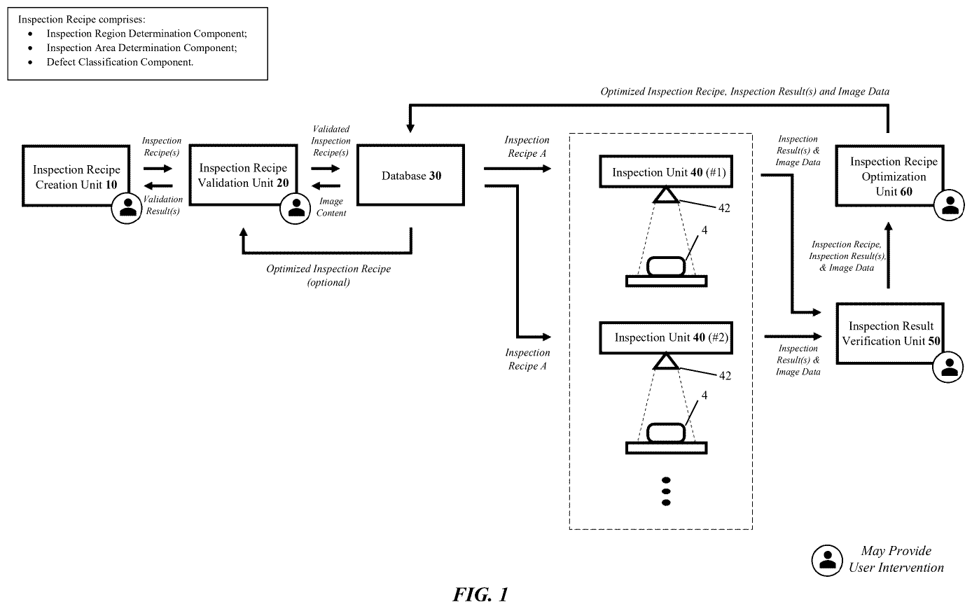

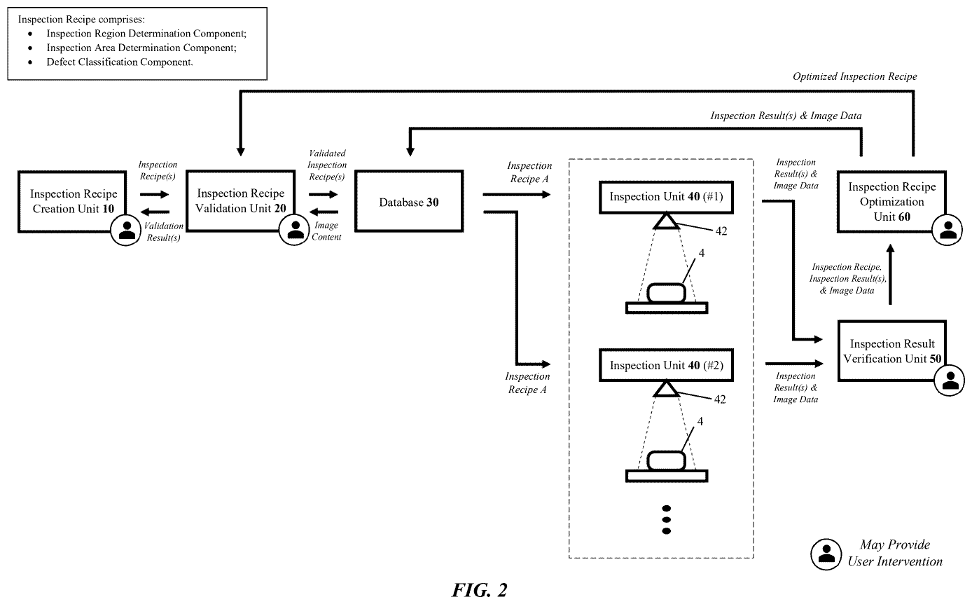

FIG. 1 illustrates an example block diagram representation of the system of the present invention for automated or semi-automated inspection of electronic assemblies according to a first example embodiment. Whereas, FIG. 2 illustrates an example block diagram representation of the system of the present invention for inspecting electronic assemblies according to a second example embodiment.

The embodiments illustrated in FIG. 1 and FIG. 2 may have similar substantially hardware and software components. With this, their similar components shall now be described.

With reference to FIG. 1 and FIG. 2, the system comprises computing units that include at least one inspection recipe creation unit 10, at least one inspection recipe validation unit 20, at least one database 30, at least one inspection unit 40 that inspects one or more electronic assemblies 4, at least one inspection result verification unit 50, and at least one inspection optimization unit 60. Each of these units may be interfaced with each other in a wired or wireless manner for them to exchange content, in the form of data, in a wired or wireless manner. Any one or a combination of these units may each be provided on-site, provided via cloud computing, or a combination thereof.

With reference to FIG. 1 and FIG. 2, the electronic assemblies 4 are objects under inspection. For each electronic assembly 4, their electronic components are to be inspected by the inspection unit 40 for the presence of defects within their electronic components (i.e. electronic component-related defects). From hereon, it is to be noted that an actual electronic assembly 4 that has undergone inspection shall be referred to as “inspected electronic assembly”.

With reference to FIG. 1 and FIG. 2, the inspection recipe creation unit 10 may be configured to [i] create at least one inspection recipe that relates to inspection of electronic components on one corresponding type of electronic assembly 4, and [ii] provide the inspection recipe to the. inspection recipe validation unit 20 for its validation.

With reference to FIG. 1 and FIG. 2, the inspection recipe validation unit 20 may be configured to validate at least one inspection recipe that is provided thereto. Furthermore, the inspection recipe validation unit 20 may also interact with the database 30 to retrieve image data content stored thereon for validation of the inspection recipes. The inspection recipes that are successfully validated may be referred to as “validated inspection recipes”. In particular, the inspection recipe validation unit 20 may be further configured to [i] manage decisions pertaining to acceptance of each inspection recipe, [ii] the management of risks associated with each inspection recipe, or a combination thereof. The inspection recipe validation unit 20 ensures that the quality of the inspection recipes is controlled for so that validated inspected recipes may be stored in the database 30.

With reference to FIG. 1 and FIG. 2, the database 30 may be configured to receive the validated inspection recipes, from the inspection recipe validation unit 20.

With reference to FIG. 1 and FIG. 2, the inspection unit 40 may be configured to perform inspection upon one or more electronic assemblies 4. More specifically, each inspection unit 40 may communicate with the database 30 for the database 30 to for one inspection recipe to be provided to the inspection unit 40. The inspection recipe that is provided may be one that is validated and/or optimized, one that is yet to be validated and/or optimized, one that was previously deployed, or one that was yet to be deployed. The inspection recipe that is provided may correspond to the type of electronic assemblies 4 to be inspected. This is so that the inspection unit 40 may execute the inspection recipe to carry out inspection upon each electronic component of each electronic assembly 4 based on the inspection recipe.

With reference to FIG. 1 and FIG. 2, the system of the present invention may include a group of inspection units 40 operating in parallel for conducting inspection of electronic components of electronic assemblies 4 (i.e. Inspection Unit (#1) and Inspection Unit (#2)). With this, it is to be noted that these inspection units 40 may be provided with an inspection recipe of the same, or may be provided with different inspection recipes.

With reference to FIG. 1 and FIG. 2, the inspection unit 40 may also be configured to execute the inspection recipe provided from the database 30 and capture one or more images of electronic components of the electronic assembly 4 that is under inspection. With that, the inspection unit 40 may identify one or more defects that may be present within electronic components of the electronic assembly 4 under inspection, based on the captured images, for one or more inspection results to be obtained.

With reference to FIG. 1 and FIG. 2, the inspection result verification unit 50 may be configured to receive at least one inspection recipe, captured images of the electronic components of the inspected electronic assembly 4 and their associated inspection results, from each inspection unit 40. The inspection recipe may be one that was previously used by the inspection unit 40, and may have a correspondence with the type of inspected electronic assemblies 4 as inspected by the inspection unit 40.

The inspection result verification unit 50 may be further configured to verify, and/or facilitate verification of, the inspection results by associating each of them to a relevant inspection verification category. In the preferred embodiment, there are inspection verification categories that include a first inspection category being a False Positive (FP) category or a second inspection category being the True Positive (TP) category. Alternatively, there may be various inspection categories that include any one or a combination of the True Positive (TP) category, False Positive (FP) category, True Negative (TN) category, False Negative (FN) category, or their complements (i.e. their “not-” counterparts). In particular, the FN category may correspond to an escapee and the FP category may correspond to a false call, whereby the inspection results are erroneous. Moreover, the TP category may correspond to a true call, whereby the inspection result is accurate.

With reference to FIG. 1 and FIG. 2, the inspection recipe optimization unit 60 may be configured to receive at least one inspection recipe, the captured images of the electronic components of the inspected electronic assemblies 4, their associated inspection results, their associated inspection verification categories. The inspection recipe may be one that was previously used by the inspection unit 40, and may have a correspondence with the type of inspected electronic assemblies 4 as inspected by the inspection unit 40.

The inspection recipe optimization unit 60 may be further configured to optimize the inspection recipe. This may enable the inspection recipe to be fine-tuned to towards specific electronic components of one specific type of electronic assembly 4, so that the accuracy of its inspection results may improve. In particular, the inspection recipe may be fine-tuned towards determining one or more defects related to electronic components that may be specific towards the specific type of electronic assembly. The inspection recipes that optimized may be referred to as “optimized inspection recipes.”With reference to FIG. 1 and FIG. 2, the database 30 may be configured to receive data content, which includes the captured images of the electronic components of the inspected electronic assemblies 4, their associated inspection results, and their associated inspection verification categories, from the inspection recipe optimization unit 60. In particular, the aforementioned data content may have a correspondence with the inspection recipe that was used for inspecting the electronic assemblies 4.

With reference to FIG. 1 and FIG. 2, the inspection recipe creation unit 10, the inspection recipe validation unit 20, the inspection result verification unit 50, and the inspection recipe optimization unit 60 may each be configured to enable a user or operator to intervene, by amending or modifying, the inspection recipe as it is generated by the inspection recipe creation unit 10, the inspection recipe as it is validated by the inspection recipe validation unit 20, the inspection verification categories verified by the inspection result verification unit 50, and the inspection recipe as it is optimized by the inspection recipe optimization unit 60, or a combination thereof.

The difference between FIG. 1 and FIG. 2 may reside in their configurations for validation of inspection recipes. With reference to FIG. 1, at least one optimized inspection recipe may be directly provided to the database 30 for its storage. With reference to FIG. 2, at least optimized inspection recipe may be provided to the inspection recipe validation unit 20 for it to be validated, and upon its successful validation, it is then provided to the database 30 for its storage.

In certain alternative embodiments, the optimized inspection recipes that were provided to the database 30 for their storage may optionally be provided to the inspection recipe validation unit 20, and upon their validation, they may be passed back to the database 30 for their storage.

In certain alternative embodiments, the inspection recipe generated by the inspection recipe creation unit 10 may be directly provided to the database 30 for to be stored therein.

In certain alternative embodiments, the captured images of the electronic components of the inspected electronic assemblies 4, their associated inspection results, and their associated inspection verification categories, may be directly provided to the database 30 from the inspection result verification unit 50 for them to be stored therein, in which them may be retrieved by the inspection recipe optimization unit 60 later on.

It is to be noted that an inspection recipe of the same may be configured to be shared between and/or used upon electronic assemblies 4 that may be of different orientations. This shall minimize the occurrence of electronic assemblies 4 being considered as escapees.

Whilst FIG. 1 and FIG. 2 have presented the inspection recipe creation unit 10, inspection recipe validation unit 20, the database 30, the inspection unit 40, the inspection result verification unit 50, and the inspection recipe optimization unit 60 as individual units, it is to be noted that one or a combination of these units may be sub-units of a larger computing unit designed or configured as so.

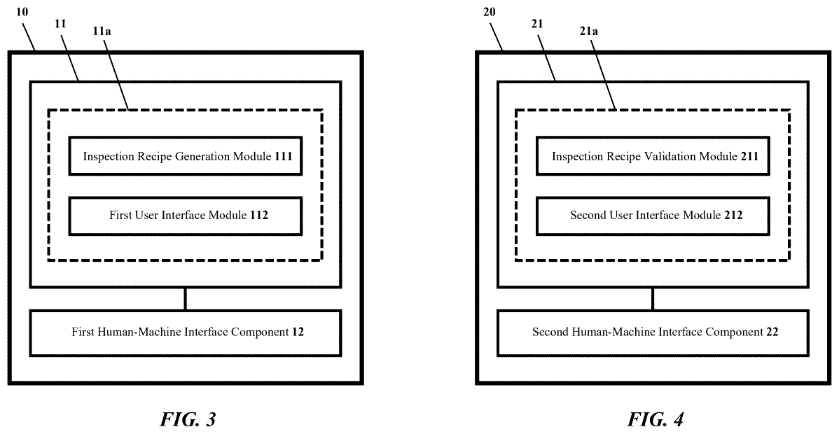

FIGS. 3-8 are example block diagram representations of the units described in FIG. 1. In particular, these units may make up one or more processors for operating a plurality of modules. More specifically, each of these units may have corresponding processors for operating one or a combination of modules.

FIG. 3 illustrates an example block diagram representation of the inspection recipe creation unit 10. As shown, the inspection recipe creation unit 10 comprises a first processor 11 running a first application software 11a that operates a plurality of modules, and a first human-machine interface (HMI) component 12. The first processor 11 and the first HMI component 12 may be substantially interfaced with each other.

With reference to FIG. 3, the first HMI component 12 is a device capable of displaying graphics thereon, for the user to interact with the inspection recipe creation unit 10.

With reference to FIG. 3, the modules operated by the first processor 11 include an inspection recipe generation module 111 and a first user interface module 112.

With reference to FIG. 3, the inspection recipe creation module 111 is involved in the generation of at least one inspection recipe that may correspond to at least one type of electronic assembly 4. It is noted that the inspection recipe creation module 111 may operate one or more machine learning models to assist in the generation of at least one inspection recipe. The inspection recipe creation module 111 may further facilitate the provision of the generated inspection recipes to the database 30.

With reference to FIG. 3, the first user interface module 112 is to operate in conjunction with the first HMI component 12. More specifically, the first user interface module 112 shall compile parameters that relate to the generation of at least one inspection recipe by the inspection recipe creation module 111 and display them on the first HMI component 12 as a user interface. The user, through the first HMI component 12 may interact with the user interface to adjust the aforementioned parameters. Alternatively, the user may let the inspection recipe creation module 111 automatically generate the inspection recipe without intervention.

With reference to FIGS. 1-3, the inspection recipe creation unit 10 may be further configured to receive validation results from the inspection recipe validation unit 20 for the generation of inspection recipes.

It is to be noted that the inspection recipe generated by the inspection recipe creation unit 10 may have the inspection region determination component, the inspection area determination component, and the defect classification component. These components may be initialized with pre-set parameters and/or values, or they may have adjusted parameters and/or values that are based on validation results that may be provided by the inspection recipe validation unit 20.

FIG. 4 illustrates an example block diagram representation of the inspection recipe validation unit 20. As shown, the inspection recipe validation unit 20 comprises a second processor 21 running a second application software 21a that operates a plurality of modules, and a second human-machine interface (HMI) component 22. The second processor 21 and the second HMI component 22 may be substantially interfaced with each other.

With reference to FIG. 4, the second human-machine interface component 22 is a device capable of displaying graphics thereon, for the user to interact with the inspection recipe creation unit 20.

With reference to FIG. 4, the modules operated by the second processor 21 include an inspection recipe validation module 211 and a second user interface module 212.

With reference to FIG. 4, the inspection recipe validation module 211 is involved in the validation of at least one inspection recipe for at least one corresponding type of electronic assembly 4, to ensure that the inspection recipe is correct and appropriate for the corresponding type of electronic assemblies 4 that are to be inspected. It is noted that the inspection recipe validation module 211 may operate one or more machine learning models to assist in the validation of at least one inspection recipe to ensure inspection recipe correctness and correspondence to the type of electronic assemblies 4. The inspection recipe validation module 211 may further facilitate the receipt of the inspection recipes generated by the inspection recipe creation unit 10, receipt of optimized inspection recipes from the inspection recipe optimization unit 60, and/or provision of validated inspection recipes to the database 30 for their storage.

With reference to FIG. 4, the inspection recipe validation module 211 may communicate with the database 30 for the database 30 to receive inspection image content 322. The inspection image content 322 may have a correspondence with the inspection recipe to be validated, and may include captured images of the electronic components of at least one corresponding type of electronic assembly 4 in which the inspection recipe to be validated may be suited, their associated inspection results, and their associated inspection verification categories. The captured images may be from at least one actual electronic assembly 4 that had been previously inspected.

It is noted that the inspection recipe validation module 211 may operate one or more machine learning models to assist in the validation of at least one inspection recipe to ensure inspection recipe correctness and correspondence to at least one type of electronic assembly.

In particular, the machine learning modules of the inspection recipe validation module 211 may form a generative adversarial network (GAN) for validating the inspection recipe. More specifically, within the inspection recipe validation module 211, there may be a first group of machine learning models that form a generator network that shall receive the inspection image content 322 for generating augmented or synthetic data content in the form of one or more artificially generated images of at least one corresponding type of electronic assembly in which the inspection recipe may be suited, wherein the artificially generated images may include one or more artificially generated images of electronic assemblies having defective electronic component, non-defective electronic components, or a combination thereof. These artificially generated images may be of one or more orientations, arrangements, or a combination thereof. The artificially generated images may include any one or a combination of two-dimensional (2D) images and three-dimensional (3D) images.

More specifically, within the inspection recipe validation module 211, there may be a second group of machine learning models that form discriminator network that shall perform validation of the inspection recipe based on the inspection image content 322, for determining that the inspection recipe is capable of performing inspection upon the corresponding type of electronic assembly. The captured images of the electronic components of at least one corresponding type of electronic assembly 4 and their artificially generated images may be used by the discriminator network for validation of the inspection recipe. Should the inspection recipe reach a predetermined inspection accuracy based on its validation results, the inspection recipe may be considered a validated inspection recipe.

As the inspection recipe is executed by the second processor 21 through the inspection recipe validation module 211, its inspection recipe determination component may perform determination and/or estimation of at least one inspection region within any one or a combination of [i] artificially generated electronic assembly images, and [ii] the captured images of one or more actual electronic assemblies 4. In particular, the inspection region may relate to one unique electronic component present within the artificially generated images or the captured images.

As the inspection recipe is executed by the second processor 21 through the inspection recipe validation module 211, the inspection area determination component of the inspection recipe may perform determination of at least one area of interest by use of bounding boxes. In particular, the inspection area may relate to areas that cover at least one unique electronic component within the artificially generated images or the captured images.

As the inspection recipe is executed by the second processor 21 through the inspection recipe validation module 211, its defect classification component may classify and/or select a suitable algorithm to be used or turned on, which may classify defects present within the area of interest on the unique electronic component on the artificially-generated electronic assembly images or the captured images. With that, the inspection recipe may produce one or more associated inspection results. The inspection recipe validation module 211 may then validate the inspection results to produce one or more associated validation results that may pertain to an inspection accuracy of the inspection recipe that is being validated.

With reference to FIG. 4, the second user interface module 212 is to operate in conjunction with the second HMI component 22. More specifically, the second user interface module 212 shall compile results that relate to the validation of an inspection recipe validated by the inspection recipe validation module 211, and display them on the second HMI component 22 as a graphical user interface. The user, through the second HMI component 22 may interact with the user interface to adjust these validation results if so desired. Alternatively, or furthermore, the user may let the inspection recipe validation module 211 automatically validate the inspection recipe without intervention.

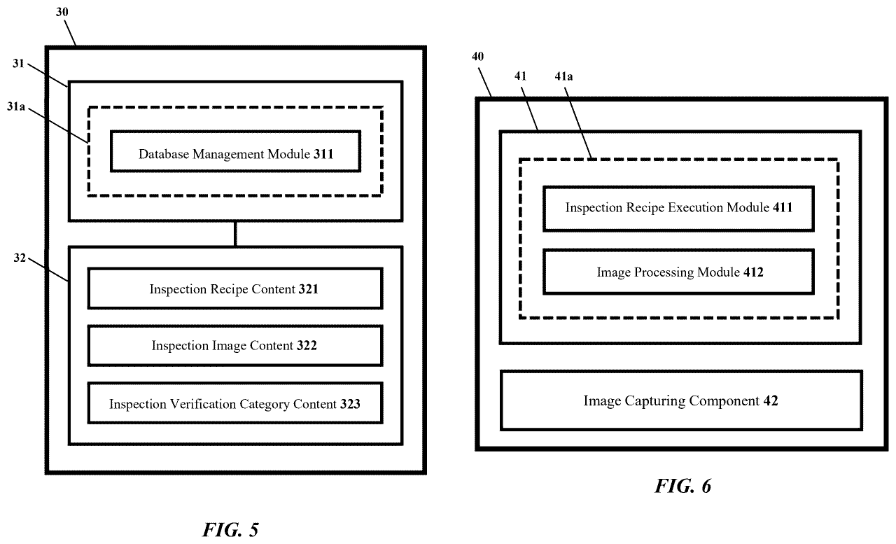

FIG. 5 illustrates an example block diagram representation of the database 30. As shown, the database 30 comprises a third processor 31 running a third application software 31a that operates a database management module 311, and at least one data storage medium 32. Preferably, the second processor 31 and the data storage medium 32 are substantially interfaced with each other.

With reference to FIG. 5, the data storage medium 32 may comprise one or more non-volatile memory units to store a library of digital content such as inspection recipe content 321, inspection image content 322, and inspection verification category content 323. The non-volatile memory unit may be, but will not be limited to, data storage devices such as hard disk drives (HDD), solid-state drives (SSD), hybrid drives, secure digital (SD) cards, TransFlash (TF) cards or the like. In embodiments where there are one or more non-volatile memory units, they are preferably set up to implement a Random Array of Independent Disks (RAID) configuration, Just-a-Bunch-of-Drives (JSOB) configuration, or the like.

With reference to FIG. 5, the database management module 311 may facilitate the provision and receipt of content between itself, and any one or a combination of the inspection unit 40, the inspection recipe creation unit 10, the inspection recipe validation unit 20, the inspection result verification unit 50, and the inspection recipe optimization unit 60. By way of example, the database management module 311 is a software that implements a relational database management system (RDBMS), using known domain-specific languages such as Structured Query Language (SQL) or file-based storage, onto the content stored in the data storage medium 32. This allows for content to be represented as one or more entries of one or more tables. These tables would have one or more primary keys and foreign keys which may be indicative of relationships between content stored in the data storage medium 32 such as the inspection recipe content 321, the inspection image content 322, and the inspection verification category 323. Furthermore, the entries of these tables may have interconnected relationships between each other such as: [i] a one-to-one relationships, [ii] a one-to-many relationships, and [iii] a many-to-many relationships. These relationships may also be expressed as classes, categories, hierarchies, or the like. Whilst not shown, the database management module 311 may further support one or more users accessing the database 30 simultaneously for creating, modifying, or removing content therewithin.

With reference to FIG. 5, the inspection recipe content 321 stored in the data storage medium 32 include data files related to one or more inspection recipes.

With reference to FIG. 5, the inspection image content 322 stored in the data storage medium 32 include image data files which are images of one or more electronic components of at least one electronic assembly 4 that were captured by the inspection unit 40 when the electronic assembly 4 was inspected by the inspection unit 40.

With reference to FIG. 5, the inspection verification category 323 stored in the data storage medium 32 include data files related to inspection verification categories associated with inspection results for a captured image of at least one electronic assembly 4, which are provided by the inspection result optimization unit 60.

FIG. 6 illustrates an example block diagram representation of the inspection unit 40 within the system of the present invention. As shown, the inspection unit 40 comprises at least one fourth processor 41 running a fourth application software 41a that operates a plurality of modules, and an image capturing component 42. Preferably, the fourth processor 41 and the image capturing component 42 are substantially interfaced with each other.

With reference to FIG. 6, the image capturing component 42 may be a device equipped with a plurality of image sensors to capture images of electronic components of one electronic assembly 4 under inspection for inspection of each electronic component, such as a camera. The image capturing component 42 may have a field of view that can at least include one electronic assembly 4 in its entirety therewithin, or portions thereof. The image sensors may be based on charged-coupled device (CCD) technology, complementary metal-oxide semiconductor (CMOS) technology, or the like.

With reference to FIG. 6, the modules operated by the fourth processor 41 include an inspection recipe execution module 411 and an image processing module 412. The inspection recipe execution module 411 may be configured to manage execution of the inspection recipe for the fourth processor 41 to operate any one or a combination of its inspection region determination component, its inspection area determination component, its defect classification component. Preferably as well, the inspection recipe is executed upon images of an electronic assembly 4 under inspection.

As the inspection recipe is executed by the fourth processor 41 through the inspection recipe execution module 411, the inspection region determination component of the inspection recipe may perform determination and/or estimation of at least one inspection region on the captured images of the electronic assembly 4 by use of bounding boxes. In particular, the inspection region may relate to one unique electronic component on the electronic assembly 4 under inspection.

As the inspection recipe is executed by the fourth processor 41 through the inspection recipe execution module 411, the inspection area determination component of the inspection recipe may perform determination of at least one area of interest on the captured images of the electronic assembly 4 based on the determined inspection regions by use of bounding boxes. In particular, the inspection area may relate to areas that cover at least one unique electronic component on the electronic assembly 4 under inspection.

As the inspection recipe is executed by the fourth processor 41 through the inspection recipe execution module 411, the defect classification component of the inspection recipe may classify and/or select a suitable algorithm to be used or turned on, which may classify defects present within the area of interest on the captured images of the electronic assembly 4 to produce one or more associated inspection results.

With reference to FIG. 6, the image processing module 412 preferably receives at least one or more images of the electronic assembly 4 that were captured by the image capturing component 42. The image processing module 412 processes these images using relevant image processing algorithms for them to be suitably used in conjunction with the inspection recipe execution module 411.

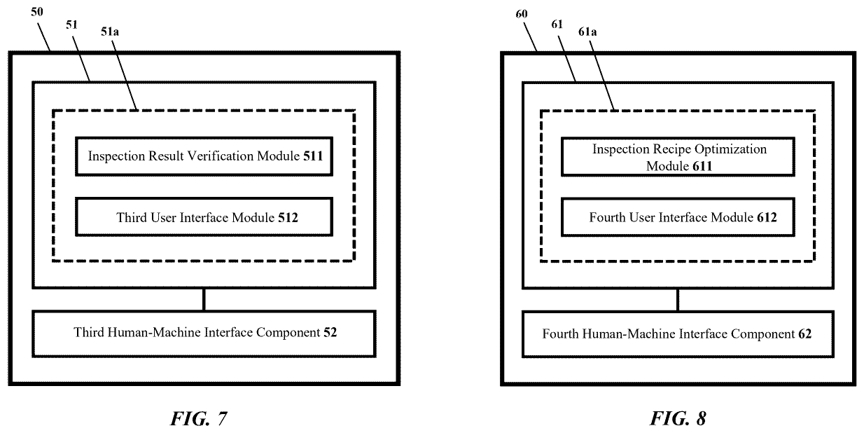

FIG. 7 illustrates an example block diagram representation of the inspection result verification unit 50. As shown, the inspection result verification unit 50 comprises a fifth processor 51 running a fifth application software 51a that operates a plurality of modules, and a third human-machine interface (HMI) component 52. The fifth processor 51 and the third HMI component 52 may be interfaced with each other.

With reference to FIG. 7, the third HMI component 52 is a device capable of displaying graphics thereon, for the user to interact with the inspection result verification unit 50.

With reference to FIG. 7, the modules operated by the fifth processor 51 include an inspection result verification module 511 and a third user interface module 512.

With reference to FIG. 7, the inspection result verification module 511 preferably receives one or more captured images that relate to electronic components of the inspected electronic assembly 4 and their associated inspection results. In particular, the inspection result verification module 511 verifies the inspection results by associating each of them to a relevant inspection verification category. It is noted that the inspection result verification module 511 may operate one or more machine learning models to assist in the verification of the inspection results.

With reference to FIG. 7, the third user interface module 512 is to operate in conjunction with the third HMI component 52. More specifically, the third user interface module 512 shall compile the captured images that relate to electronic components of the inspected electronic assembly 4, their associated inspection results from at least one inspection unit 40, and their associated inspection verification categories, and display them on the third HMI component 52 via a graphical user interface. The user, through the third HMI component 42 may interact with the user interface to further verify the inspection results and/or the inspection verification categories. Should there be errors, the user may intervene by amending or modifying, the inspection verification categories for them to be accurate.

FIG. 8 illustrates an example block diagram representation of the inspection recipe optimization unit 60. As shown, the inspection recipe optimization unit 60 comprises a sixth processor 61 running a sixth application software 61a that operates a plurality of modules, and a fourth human-machine interface (HMI) component 62. The sixth processor 61 and the fourth HMI component 62 may be interfaced with each other.

With reference to FIG. 8, the fourth HMI component 62 is a device capable of displaying graphics, for the user to interact with inspection recipe optimization unit 60.

With reference to FIG. 8, the modules operated by the sixth processor 61 include an inspection recipe optimization module 611 and a fourth user interface module 612

With reference to FIG. 8, the inspection recipe optimization module 611 may receive an inspection recipe, captured images of the electronic components of one corresponding inspected electronic assembly 4 in which the inspection recipe is suited thereto, their associated inspection results, and their associated inspection verification categories as inputs. More specifically, the inspection recipe may be fine-tuned by the inspection recipe optimization module 611 for it to adapt to a specific electronic assembly.

Furthermore, the inspection recipe optimization module 611 may operate one or more machine learning models, which may assist a user in fine-tuning at least one inspection recipe it to adapt to at least one electronic component of at least one specific electronic assembly, in which the inspection recipe may be suited thereto.

With reference to FIG. 8, the fourth user interface module 612 is to operate in conjunction with the fourth HMI component 62. More specifically, the fourth user interface module 612 shall compile information or data content from the inspection recipe optimization module 611 and display them on the fourth HMI component 62 as a graphical user interface. The user, through the fourth HMI component 62 may interact with the user interface to adjust the components of the inspection recipe updating or changing i parameters and/or values that may relate to a type of inspection to be performed by the inspection recipe via the inspection unit 40.

As the inspection recipe is executed by the sixth processor 61 through the inspection recipe optimization module 611, its inspection region determination component, its inspection area region determination component, and its defect classification component may operate as previously described for the inspection recipe validation unit 20 and the inspection unit 40, preferably upon the captured images of at least one corresponding type of electronic assembly 4. In addition to this, parameters related to these components may be extracted and for these parameters to be adjusted accordingly. In particular, parameters related to these components may be displayed on the fourth HMI component 62 for them to be viewed and/or adjusted by the user.

In certain embodiments, the inspection recipe optimization module 611 may share similarities with the inspection recipe validation module 211, in which the inspection recipe optimization module 611 may form a generative adversarial network (GAN), to perform a training process for training the inspection recipe. Similarly, the inspection recipe optimization module 511 may have a generator network and a discriminator network that may function in a manner similar to those of the inspection recipe validation module 211. Thus, their descriptions thereof shall not be repeated.

It is noted that for the rest of the description, the hardware and software components of the system may not be directly implicated. However, it is to be understood by a skilled person that the descriptions of the hardware and software components above provide support for the rest of the description.

Furthermore, it should be noted that while the aforementioned modules may have been described to be in a software embodiment, they may also be in a hardware embodiment where they are directly connected to the processor. Alternatively, these modules may each be an independent computing sub-unit.

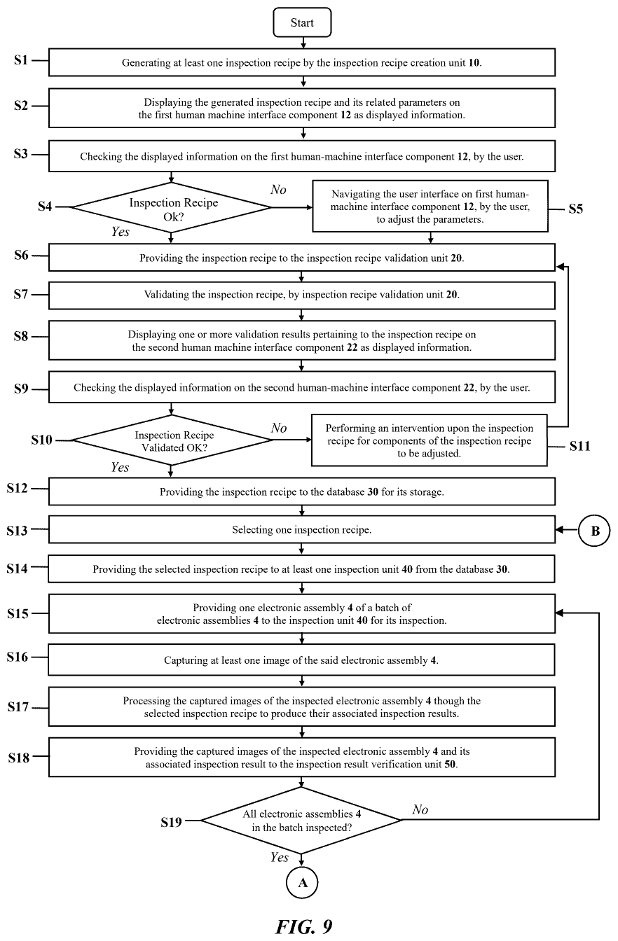

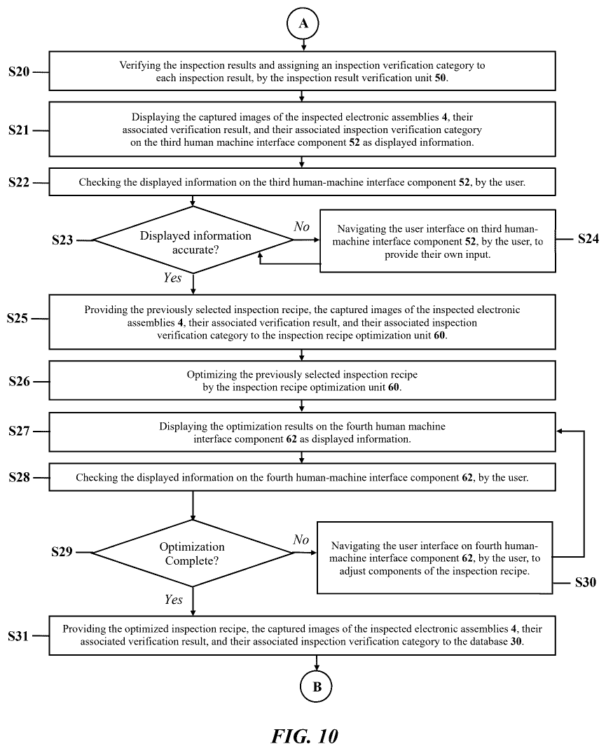

FIGS. 9-10, in combination, illustrate a flowchart describing an example method of the present invention for automated or semi-automated inspection of electronic assemblies. It is noted that the steps described in these flowcharts are not to be interpreted as non-limiting, and minor modifications to the steps (e.g. additions, omissions, repetitions, or swaps) are permissible by a skilled person without substantial deviation from as described.

First, in Step S1, the step of generating at least one inspection recipe by the inspection recipe creation unit 10 is performed. More specifically, this step may be performed by the inspection recipe generation module 111, upon being prompted by the user.

Following Step S1 is Step S2. Step S2 involves displaying the generated inspection recipe and its related parameters on the first HMI component 12 as displayed information.

Following Step S2 is Step S3. Step S3 involves checking the displayed information on the first HMI component 12. This step may be carried out by the user.

Following Step S3 is Step S4. Step S4 is a decision step whereby it is determined whether or not the inspection recipe as generated by the inspection recipe generation module 111 is acceptable. This step may be carried out by the user. Should this not be the case, Step S4 shall proceed to Step S5. Should this be the case, Step S4 proceeds to Step S6.

In Step S5, since it was determined that the inspection recipe as generated by the inspection recipe generation module 111 is not acceptable, the step of adjusting the parameters of the inspection recipe generation module 111 related to the generation of the inspection recipe is performed. This step may be performed by the user via the user interface as displayed on the first HMI component 12. With this, Step S5 may proceed to Step S6.

In Step S6, since it was determined that the inspection recipe as generated by the inspection recipe generation module 111 is acceptable, the step of providing the inspection recipe to the inspection recipe validation module 20 for its validation performed. This step may be facilitated by the inspection recipe validation module 211.

Following Step S6 is Step S7. Step S7 involves validating the inspection recipe, by the inspection recipe validation unit 20. This step may be performed by the inspection recipe validation module 211 that may execute the inspection recipe and its components in a simulated setting or environment. In particular, the inspection recipe validation module 211 may communicate with the database 30 for it to provide the inspection recipe with inspection image content 322 that pertains to one or more stored images of different types of electronic assemblies or electronic assemblies of the same type for the inspection recipe to perform inspection thereupon. In certain embodiments, the inspection recipe validation module 211 may perform generation of synthetic or augmented data that may include artificially-generated images for validating the inspection recipe. With that, one or more validation results may be generated by the inspection recipe validation module 211.

Following Step S7 is Step S8. Step S8 involves displaying the validation results on the second human machine interface component 22 as displayed information.

Following Step S8 is Step S9. Step S9 involves checking the displayed information on the second HMI component 22. This step may be carried out by the user.

Following Step S9 is Step S10. Step S10 is a decision step whereby it is determined whether or not the inspection recipe validated by the inspection recipe validation module 211 is acceptable based on its validation results. This step may be carried out by the user or the inspection recipe validation module 211. Should this not be the case, Step S10 shall proceed to Step S11. Should this be the case, Step S10 proceeds to Step S12.

In Step S11, since it was determined that the inspection recipe as generated by the inspection recipe generation module 111 is not acceptable based on its validation results, the step performing an intervention upon components of the inspection recipe for their parameters to be adjusted. With that, step S11 may return to Step S6 and repeat therefrom for the inspection recipe to be validated one again.

In Step S12, since it was determined that the inspection recipe as generated by the inspection recipe generation module 111 is acceptable based on its validation results, the step of providing the inspection recipe to the database 30 for its storage as content is performed. This step may be facilitated by the inspection recipe validation module 211.

Following Step S12 is Step S13. Step S13 involves selecting an inspection recipe for an inspection process. In particular, this step may be performed by the user that may currently be interacting with the inspection unit 40 and/or database 30, or via their own end-user device. The selection of the inspection recipe may be based on the type of electronic assembly 4 to be inspected. Furthermore, the selected inspection recipe may have yet to be optimized, or had been optimized previously.

Following Step S13 is Step S14. Step S14 involves providing at least one inspection recipe, which may be the selected inspection recipe, to at least one inspection unit 40. This step may be done by the database 30 upon request from the inspection unit 40. With this, the inspection recipe may be loaded to the inspection recipe execution module 411 and its related sub-modules.

Following Step S14 is Step S15. Step S15 involves conveying one electronic assembly 4 of a batch of electronic assemblies 4 to the inspection unit 40 for its inspection. In particular, each electronic assembly 4 within the batch may be of a type of the same.

Following Step S15 is Step S16. Step S16 involves capturing one or more images of the electronic assembly 4 by the image capturing component 42 of the inspection unit 40. More specifically, one or more images of the electronic components of the electronic assembly 4 are captured.

Following Step S16 is Step S17. Step S17 involves processing the images of the electronic assembly 4 that were captured by the image capturing component 42. This step may be performed by the inspection recipe execution module 411 and the image processing module 412. The image processing module 412 may enable the images to become suited for performing inspection thereupon, while the inspection recipe execution module 411 may execute at least one inspection recipe and its related components upon the captured images to generate its associated inspection results.

Following Step S17 is S18. Step S18 involves providing the captured images of the inspected electronic assembly 4 and its associated inspection results to the inspection result verification unit 50.

Following Step S18 is Step S19. Step S19 is a decision step whereby it is determined whether or not all electronic assemblies 4 in the batch have been inspected. Should this be the case, Step S19 proceeds to Step S20. Else, Step S19 returns to Step S15 for a subsequent electronic assembly 4, from the batch, to be inspected.

In Step S20, since it was determined that all electronic assemblies 4 from the batch had been inspected, the step of verifying the inspection results is performed. This step may be performed by the inspection result verification unit 50. More specifically, the inspection result verification module 511 may operate its own machine learning models and/or make rule-based decisions for automated verification of the inspection results by associating each of them to a relevant inspection verification category.

Following Step S20 is Step S21. Step S21 involves displaying any one or a combination of the captured images of the inspected electronic assemblies 4, their associated verification result, and their associated inspection verification category on the third HMI component 52 as displayed information. This step may be facilitated by the third user interface module 512. More specifically, for each inspected electronic assembly 4, the captured images of its electronic components, its associated inspection result, and its associated inspection verification category, may be displayed on the third HMI component 52 via a user interface.

Following Step S21 is Step S22. Step S22 involves checking the information as displayed on the third HMI component 52. This step may be carried out by the user. As per the preferred embodiment, the information displayed on the third HMI component 52 may be selectively displayed, with electronic assemblies 4 that have an associated inspection verification category that fall under the categories of the first inspection verification categories (i.e. the False Positive (FP) categories) and second inspection verification categories (i.e. the True Positive (TP) categories) being displayed. In particular, the displayed information may be presented on the user interface in a tabulated manner. It is to be noted that any other type and/or number of inspection categories, as previously described, may be configured to be displayed thereon.

Following Step S22 is Step S23. Step S23 is a decision step whereby it is determined, by the user, whether or not the inspection result and/or the inspection verification categories for the captured images of the electronic components of the inspected electronic assembly 4 is accurate. Should this not be the case, Step S23 shall proceed to Step S24. Should this be the case, Step S23 proceeds to Step S25.

In Step S24, since it was determined that there are inspection results and/or the inspection verification categories are not accurate, the user may navigate the user interface displayed on the third HMI component 52 to provide their own input on the inspection verification categories. For example, they may key-in and/or amend any one or both the inspection result and the inspection verification categories accordingly. With this, Step S24 may return to Step S23 and repeat therefrom.

It is to be noted that, in one alternative embodiment, the step of verifying the inspection results may not be automatically performed by the inspection result verification unit 50. In such an embodiment, the inspection result verification unit 50 may provide captured images of the electronic components through the third HMI component 52 for the user to provide their own input on the inspection verification categories for each image, which may be either the first inspection verification category (i.e. the False Positive (FP) category) or the second inspection verification category (i.e. the True Positive (TP) category).

Following Step S24 is Step S25. Step S25 involves providing at least one inspection recipe that may be previously selected, the captured images of the electronic components of the inspected electronic assemblies 4, their associated inspection results, and their associated inspection verification categories to the inspection recipe optimization unit 60. This step may be done by the inspection result verification unit 50.

Following Step S25 is Step S26. Step S26 involves optimizing at least one inspection recipe, which may be the previously selected inspection recipe. This step may be done by the inspection recipe optimization module 611. In particular, the inspection recipe optimization module 611 is provided with the captured images of the electronic components of the inspected electronic assemblies 4, their associated inspection results, and their associated verified inspection results as input. Furthermore, the inspection recipe optimization module 611 may be configured to execute the inspection recipe that was previously used by the inspection unit 40 upon the captured images. Moreover, the inspection recipe optimization module 611 may be configured to extract parameters related to the components of the inspection recipe.

Following Step S26 is Step S27. Step S27 involves displaying the optimization results on the fourth HMI component 62 as displayed information via a graphical user interface. This step may be facilitated by the fourth user interface module 612.

Following Step S27 is Step S28. Step S28 involves checking the displayed information on the fourth HMI component 62. This step may be carried out by the user.

Following Step S28 is Step S29. Step S29 is a decision step whereby it is determined whether or not the optimization of the inspection recipe as performed by the inspection recipe optimization module 611 is acceptable. This step may be carried out by the user.

Should this not be the case, Step S29 proceeds to Step S30. Should this be the case, Step S29 proceeds to Step S31. In Step S30, since it was determined that the optimization of the inspection recipe as performed by the inspection recipe optimization module 611 is not acceptable, the step of adjusting inspection parameters is of the inspection recipe performed. This step may be performed by the user via the user interface displayed on the fourth HMI component 62. By way of example, the user may interact with the user interface on the fourth HMI component 62 for performing manual fine-tuning of the inspection parameters of the components of the inspection recipe, prompt the inspection recipe optimization module 611 to perform automatic fixing of the inspection recipe, or a combination thereof. With this, Step S30 may return to Step S27 and repeat therefrom.

In one embodiment, the inspection optimization module 611 may operate in an automated manner for automatically fixing any one or a combination of warnings that arise during the optimization of the inspection recipe. More specifically, these warnings may be represented as quantitative or numerical parameters, and should these warning parameters be within a pre-defined coverage or range as imposed or enforced by the inspection recipe optimization module 611, it shall perform the automatic fixing of the inspection recipe by fine-tuning inspection parameters of the components of the inspection recipe. In yet another embodiment, the user interface on the fourth HMI component 62 may prompt and enable the user to perform manual fine-tuning of the parameters of the components of the inspection recipe. It is to be noted that the inspection recipe optimization unit 60 may be configured to implement any one or both of the aforementioned embodiments for performing any one or a combination of steps S26 to S30. Moreover, the pre-defined coverage or range of the warning parameters may be set by the user prior to operation of the inspection recipe optimization unit 60. With that, after the automated fix and/or manual fine-tuning is done, optimization results may be displayed on the fourth HMI component 62.

In Step S31, since it was determined that the optimization of the inspection recipe as performed by the inspection recipe optimization module 611 is acceptable, the step of providing the optimized inspection recipe to the database 30 is performed. Furthermore, the captured images of the inspected electronic assemblies 4, their associated inspection results, and their associated inspection verification categories may also be provided to the database 30. With this, the optimized inspection recipe may be ready to be provided to the inspection units 40 when the inspection recipe is selected to be used upon a future batch of electronic assemblies 4 by continuing from step S13.

In an alternative sequence of steps according to the second example embodiment of the system of the present invention. The optimized inspection recipe may instead be provided to the inspection recipe validation unit 20 for its validation by returning to step S6, while the captured images of the inspected electronic assemblies 4, their associated verification result, and their associated inspection verification category may be provided the database 30 for their storage.

For the present application, whilst it had been described that the modules 111, 211, 311, 411, 511 and 611 are each operated by their corresponding processors, it should be noted that in certain embodiments, any one or a combination of the aforementioned modules may be operated by one processor of the same.

Furthermore, in certain embodiments of the present application, it is to be noted that the inspection recipe validation module 211 and the inspection recipe generation module 111 may have a closed-loop control interaction in which they may form a first composite generative adversarial network (GAN) framework. In particular, the inspection recipe generation module 111 act as a “generator” and may generate and provide generated inspection recipes to the inspection recipe validation module 211 recipe for their validation. In particular, the inspection recipe validation module 211 may be further configured to act as a “discriminator” to validate the inspection recipe.

With that, parameters of the machine learning models of the inspection recipe generation module 111 may affect parameters of the machine learning models of the inspection recipe validation module 211, and/or vice versa. This may allow the inspection recipe generated by the inspection recipe generation module 111 to improve over time, as well as the validation performance of the inspection recipe validation module 211 to improve over time.

Furthermore, in certain embodiments of the present application, it is to be noted that the inspection recipe validation module 211 and the inspection recipe optimization module 611 may have a closed-loop control interaction in which they may form, or further form, a second composite generative adversarial network (GAN) framework. In particular, the inspection recipe optimization module 611 act as a “generator” and may provide optimized inspection recipes to the inspection recipe validation module 211 recipe for their validation. In particular, the inspection recipe validation module 211 may be further configured to act as a “discriminator” to validate the optimized inspection recipe, for optimized inspection recipes that are validated to be stored in the database 30. With that, inspection parameters of the components of one inspection recipe may keep on improving over time as the inspection recipe is continuously validated and optimized in a cyclical manner.

In conclusion, the present invention has provided a system and method for automated or semi-automated inspection of electronic assemblies as described. It is to be noted its applications as described may be further generalized to other inspection applications. The present disclosure includes as contained in the appended claims, as well as that of the foregoing description. Although this invention has been described in its preferred form, it is understood that the present disclosure of the preferred form has been made only by way of example and numerous changes in the details of the construction, combination and arrangements of parts may be resorted to without departing from the scope of the invention.

1. A system for automated or semi-automated inspection of electronic assemblies, comprising:
at least one image capturing component for capturing images of one or more electronic components of at least one electronic assembly under inspection;
at least one database for storing one or more inspection recipes and the images; and
one or more processors operating a plurality of modules that include any one, or a combination of, at least one inspection recipe validation module, and at least one inspection recipe optimization module;
wherein
the inspection recipes are each executed by at least one processor for inspection of at least one electronic assembly based on the images;
the inspection recipe validation module is configured to validate the inspection recipes; and
the inspection recipe optimization module is configured to optimize the inspection recipes based on the images, associated inspection results of the images, associated inspection verification categories of the images, or a combination thereof.

2. The system according to claim 1, wherein the inspection recipe validation module is further configured to validate at least one inspection recipe based on any one or both the images from the database and images that are artificially-generated by the inspection recipe validation module based on the images from the database, for validated inspection recipes to be stored in the database.

3. The system according to claim 1, wherein the inspection recipe optimization module is further configured to optimize one inspection recipe that was executed for inspection of one corresponding type of electronic assembly, in which the inspection recipe is fine-tuned to determine specific electronic component-related defects on the electronic assembly.

4. The system according to claim 3, wherein the inspection recipe validation module is further configured to receive at least one inspection recipe that was optimized by the inspection recipe optimization module for its validation.

5. The system according to claim 1, wherein the inspection recipes each comprise:
an inspection region determination component, which is configured to determine at least one inspection region within the images, upon execution of the inspection recipe;
an inspection area determination component, which is configured to determine at least one area of interest within the determined inspection regions, upon execution of the inspection recipe; and
a defect classification determination component, which is configured to determine at least one defect from the determined area of interest, upon execution of the inspection recipe.

6. The system according to claim 1, wherein the modules further include any one or a combination of:
an inspection recipe generation module, which is configured to generate the one or more inspection recipes;
an inspection recipe execution module, which is configured to manage execution of at least one inspection recipe for inspecting the electronic assembly based on the images to produce the associated inspection results; and
an inspection result verification module, which configured to produce the associated inspection verification categories based on any one or both the images of the electronic assembly under inspection and the associated inspection results.

7. A method for automated or semi-automated inspection of electronic assemblies, comprising the steps of:
storing one or more inspection recipes in at least one database;
capturing images of one or more electronic components of at least one electronic assembly under inspection, by at least one image capturing component;
storing the images in at least one database; and
operating a plurality of modules, by one or more processors, in which the modules include any one or a combination of at least one inspection recipe validation module, and at least one inspection recipe optimization module;
wherein
the inspection recipes are each executed by at least one processor for inspection of at least one electronic assembly based on the images;
the inspection recipe validation module is configured to validate the inspection recipes; and
the inspection recipe optimization module is configured to optimize the inspection recipes based on the images, associated inspection results of the images, associated inspection verification categories of the images, or a combination thereof.

8. The method according to claim 7, further comprising the step of validating at least one inspection recipe based on any one or both the images from the database and images that are artificially-generated based on the images from the database, by the inspection recipe validation module.

9. The method according to claim 7, further comprising the step of optimizing at least one inspection recipe that was executed for inspection of one corresponding type of electronic assembly for fine-tuning the inspection recipe for it to determine specific electronic component-related defects on the corresponding type of electronic assembly, by the inspection recipe optimization module.

10. The method according to claim 9, further comprising the step of receiving at least one inspection recipe that was optimized by the inspection recipe optimization module, by the inspection recipe validation module, for its validation.
